(19) United States
(12) Patent Application Publication
(10) Pub. No.: US 2004/0195513 A1
(43) Pub. Date: Oct. 7, 2004

(54) Densifying deposited films on an integrated circuit

(76) Inventors: George Zentai, Mountain View, CA (US); Kanai S. Shah, Newton, MA (US); Paul R. Bennett, Acton, MA (US); Mikhail Klugerman, Acton, MA (US); Yuri Dmitriev, Brighton, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/405,599

(22) Filed: Apr. 1, 2003

(51) Int. Cl. G01T 1/24

(52) U.S. Cl. 250/370.01; 264/570

(57) ABSTRACT

Densifying a deposited semiconducting film on a substrate is described. According to one embodiment of the invention, isostatic pressure is used to densify the semiconducting film on the substrate.

### TECHNICAL FIELD

Embodiments of the invention relate to the field of substrate processing; and, more specifically, to a process of depositing a semiconducting film layer onto an integrated circuit.

### BACKGROUND

A common design for the construction of a radiation detector may include a semiconductor layer deposited onto a substrate that serves as both mechanical support for the film and provides an electronic connection to signal processing circuitry. In this design, the semiconductor layer acts as both absorber of the incident radiation and converter to electronic signal. Necessary to this scheme is the deposition of the semiconducting film directly onto the substrate. This deposition can be performed using various techniques well known in the art such as physical vapor deposition (e.g., evaporation, sputtering), chemical vapor deposition, or screen-printing.

Typically, after deposition of the crystallites making up the ‘as-deposited’ semiconducting film, the resulting film is highly polycrystalline with grains of largely random orientation due to the crystallites on the substrate not joining or merging to become a single continuous layer. The result is spaces (e.g., gaps) between grains that are filled, presumably, with air upon removal from a deposition chamber and diffusion.

Such films are easy to damage if anything mechanical comes in contact with the film surface. The grains are bonded to each other very weakly and could easily be removed. It is well known that some type of electronic contact (e.g., wire or similar) must eventually be made to this top surface if an electrical bias is to be applied, and that this connection is highly suspect when the films cannot withstand most bonding operations.

Furthermore, the surface topology of the film is highly irregular, with some grains projecting tens of microns from the adjacent surface. Scanning electron micrographs would also confirm that the film could have a ‘needle-like’ appearance. This produces a highly noncontiguous surface that is not conductive to applying a covering electrode. Typically, electrodes are applied by a common physical vapor deposition method (e.g., evaporation method) that produces a layer of thin metal with a thickness that is in the range of hundreds to thousands of angstroms, that is, far smaller than the surface roughness of the film. Thus, it is challenging to produce a continuous metallic layer that connects all points of the top surface, often leaving open circuits along the vast areas.

In addition, it is hypothesized that the open grain structure of the surface would leave the film's bulk susceptible to incorporating many contaminants and changing its properties. Amongst the possible contaminants are the deposited metal electrode, solvents associated with any wire bonding, surface treatments or encapsulation, and air or water vapor.

### SUMMARY OF AN EMBODMENT THE INVENTION

Densifying a deposited semiconducting film on a substrate is described. According to one embodiment of the invention, isostatic pressure is used to densify the semiconducting film on the substrate.

### BRIEF DESCRIPTION OF THE DRAWINGS

Embodiments of the invention may best be understood by referring to the following description and accompanying drawings that are used to illustrate embodiments of the invention. In the drawings:

FIG. 1 illustrates one embodiment of a cross-sectional view of an integrated circuit having a densified semiconducting layer;

FIG. 2 illustrates one embodiment of densifying a lead iodide film on a substrate;

FIG. 3 illustrates one embodiment of an isostatic pressing process flow for densifying the lead iodide film layer onto an integrated circuit;

FIG. 4 illustrates one embodiment of a cross-sectional view of an integrated circuit having the deposited lead iodide film layer prior to the isostatic pressing, as described in FIG. 3; and

FIG. 5 illustrates one embodiment of a cross-sectional view of the lead iodide film layer after isostatic pressure, as described in FIG. 3.

### DETAILED DESCRIPTION

Densifying a deposited semiconducting film on a substrate with a pressing action is described. In the following description, numerous specific details are set forth. However, it is understood that embodiments of the invention may be practiced without these specific details. In other instances, well-known circuits, structures and techniques have not been shown in detail in order not to obscure the understanding of this description. As will be appreciated, densification of the deposited semiconducting film lessens the gaps between the grains of the film, enhances the adhesion of the deposited semiconducting film to the underlying substrate, produces greater mechanical strength, smoothes the topology of the film, and can alter and also improve the film's electrical properties, as will be further described below.

The following describes an embodiment of using an isostatic pressing technique for the purpose of densifying a deposited lead iodide (PbI₂) film on an integrated circuit assembly. However, alternative pressing techniques (e.g., mechanical pressing and heat) and alternative semiconducting films (e.g., Bismuth Iodide (BiI₂), Bismuth Triodide (BiI₃) Mercuric Iodide (HgI₂), among other semiconducting materials) well known to those of ordinary skill in the art may also be used. Furthermore, amongst the variants of isostatic pressing techniques, the following describes using cold isostatic pressing (CIP). Cold isostatic pressing is performed at or near room temperature with the pressure being applied through a liquid (e.g., water or oil), as will be described.

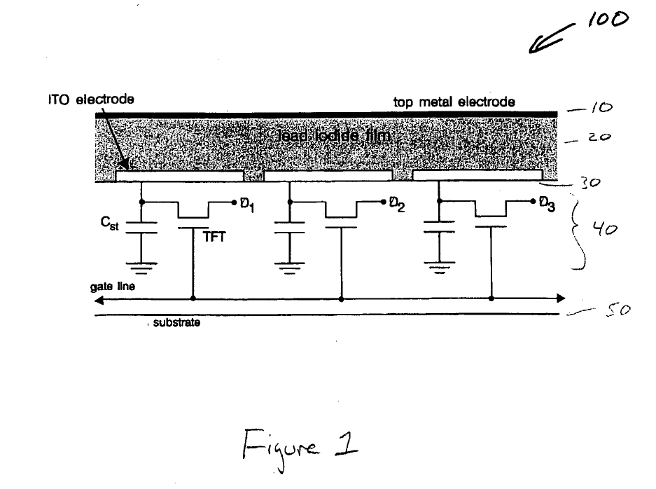

FIG. 1 illustrates one embodiment of a cross-sectional view of an integrated circuit 100 with a pressed lead iodide film layer. The integrated circuit 100 includes a top metal electrode 10, a lead iodide film layer 20, contact pads 30, electronic circuitry 40, and a substrate 50.

Such integrated circuits can have a wide variety of uses. For example, the integrated circuit 100 may be used as a sensor on a digital imaging device (e.g., an X-ray detector) where the purpose of the densified lead iodide semiconducting layer is to absorb incident x-ray quanta and convert their energy into electronic charge pairs (electrons and holes) that can be measured with external circuitry to determine the magnitude of the x-ray flux. The electronic integrated circuit may amplify or store the signal to provide signal storage and amplification, provide pixellation of the densified, lead iodide, semiconducting layer, or also serve as a mechanical support for the lead iodide semiconductor layer.

During the construction of the integrated circuit 100, the lead iodide film may have been deposited on the top of the contact pads 30 and electronic circuitry 40, followed by deposition of a metal electrode 10 being deposited on top. The lead iodide layer 20 may have been deposited with a thermal evaporation process well known to those of ordinary skill in the art. The substrate 50 may be made of a fragile material such as glass. Construction of an integrated circuit having a semiconducting layer is well known in the art, and according, a detailed description is omitted so as to not obscure the nature of the invention.

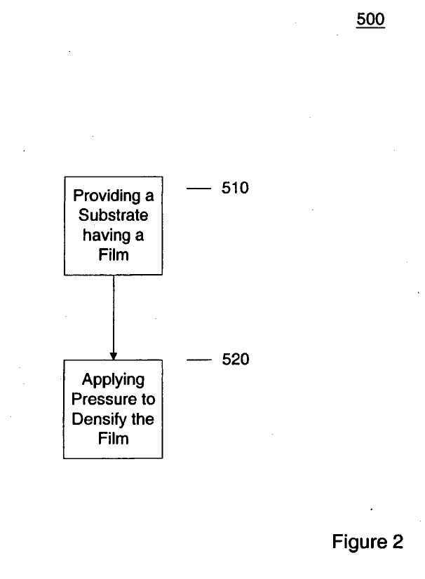

FIG. 2 illustrates one embodiment of densifying a lead iodide film on a substrate (500). At block 510, a substrate is provided having the lead iodide film. At block 520, pressure is applied to densify the lead iodide film. As will be described further below, densification of the deposited semiconducting film lessens the gaps within the film, enhances the adhesion of the deposited semiconducting film to the underlying substrate, produces greater mechanical strength, and smoothes the topology of the film.

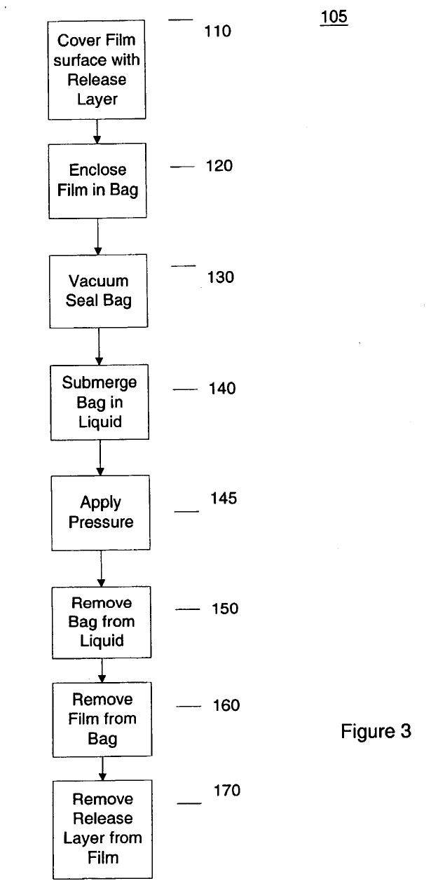

FIG. 3 illustrates one embodiment of an isostatic pressing process flow 105 for densifying a deposited lead iodide film layer on an integrated circuit before the top electrode is deposited. At block 110, the surface of the lead iodide film layer 20 is treated with a release layer. The applying of the release layer may mitigate damage that may occur during the unbagging process, as will be described below. For example, the surface of the lead iodide film layer 20 may be covered with a Teflon sheet. The Teflon sheet may be a 15 mil Teflon sheet which may be easily removed after the pressing process is complete, to lessen the damage to the film. It should be understood that the invention is not limited to the use of a Teflon sheet. In alternative embodiments, a thin sheet (10 mil or less) of stainless steel may be used, as well as other thin, flexible thermoplastic.

At block 120, the integrated circuit 100 having the deposited lead iodide film layer 20 is enclosed in a liquid tight enclosure. The enclosure, such as a bag, will protect the film from moisture and also provide the medium through which the pressure is applied, as described below. In one embodiment, a bag type enclosure is made from polynatural 6 mil clean room quality tubes well known to those of ordinary skill in the art. The release layer is between the bag and the surface of the lead iodide film layer 20.

At block 130, the bag is vacuum-sealed. In one embodiment, the bag is sealed with a heat sealer while being evacuated with a vacuum pump. In one embodiment, the integrated circuit 100 having the deposited lead iodide film layer 20 may be enclosed in multiple bags (e.g., two bags). This way the lead iodide layer 20 is protected in the event one bag should fail to seal properly.

At block 140, the bag enclosing the integrated circuit 100 having the lead iodide layer 20 is submerged in a liquid within a compression chamber where the isostatic pressing occurs. The liquids that may be used include, for example, water and hydraulic oil. Alternatively other liquids may be used.

At block 145, the compression chamber applies isostatic pressure to the bag enclosing the integrated circuit 100 having the lead iodide layer 20. Having the pressure applied while the bag is submerged in the liquid allows the pressure to be applied evenly about the entire integrated circuit 100. In one embodiment, the pressing condition applied is cold isostatic pressing in the five to sixty kpsi range (thousand pounds per square inch) and, for example, at approximately 30 kpsi, for approximately one minute to five minutes at room temperature. It should be understood that at elevated temperatures, however, during either warm (WIP) or hot (HIP) isostatic pressing with other materials, extended periods of time are customary (e.g., ranging to many hours).

It should be appreciated that having the integrated circuit with the lead iodide film layer 20 enclosed during the process prevents the contamination of the film by the liquid, and increases the pressing effectiveness, otherwise, the liquid would be pushed into the voids between grains with little net effect on the grains themselves.

At block 150, the bag is removed from the liquid.

At block 160, the integrated circuit having the densified lead iodide film layer 20 is removed from the bag.

At block 170, the release layer (e.g., Teflon sheet) is removed from the densified lead iodide film layer. The densified lead iodide film is now available for further processing and/or testing.

In one embodiment, multiple integrated circuits each having a deposited lead iodide film layer may be processed at the same time depending, for example, on the size of the compression chamber utilized.

It should be understood that the isostatic pressing may be performed at varied pressures (e.g., 5 kpsi to 60 kpsi). In addition, alternative isostatic pressing techniques may also be performed at elevated temperatures, other than room temperature, such as, for example, warm isostatic pressing at temperatures of 150 degrees Celsius to 200 degrees, or hot isostatic pressing at 200 degrees Celsius or greater.

In one embodiment, the lead iodide film layer 20 may be initially deposited by thermal evaporation on a cooler temperature substrate (e.g., on indium-tin-oxide (ITO) coated glasses). The process may involve the preparation of the integrated circuit, the fixturning of the integrated circuit to a heater, deposition of the lead iodide film, and cool down of the lead iodide film prior to exposure to air. In one embodiment, the lead iodide film is deposited at a base pressure of approximately 1×10⁻⁶ Torr. It should be appreciated that, as deposited, the lead iodide film layer may have a bulk density of roughly fifty percent of the 6.2 g/cm3 characteristic of crystalline lead iodide.

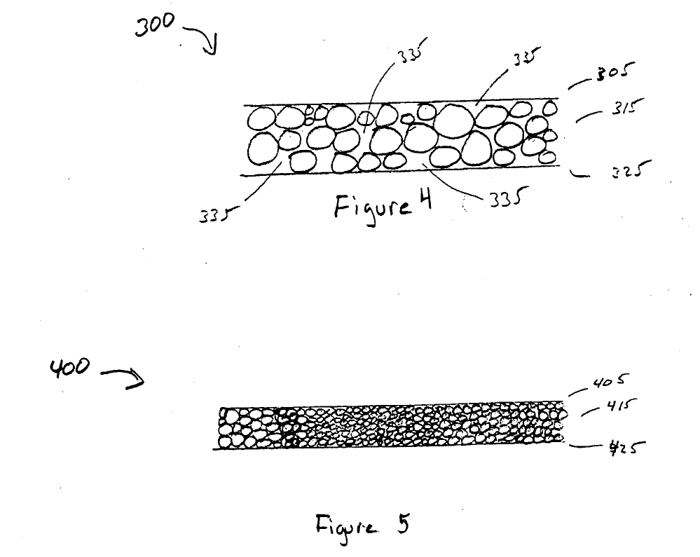

FIG. 4 illustrates a cross-sectional view of an integrated circuit having the as-deposited lead iodide film prior to the isostatic pressing, as described in FIG. 3. The integrated circuit 300 is shown having a top electrode 305, a deposited lead iodide layer 315, and an ITO electrode 325. The density of the crystalline lead iodide film causes multiple gaps 335. This produces a highly noncontiguous surface that is not conducive to applying the top electrode 305. In this way, the top electrode layer 305 may not connect with all points of the top surface of the lead iodide layer, which may leave open circuits along the vast surface area. Furthermore, the open grain structure of the lead iodide surface may leave the lead iodide film's bulk susceptible to incorporating many contaminants (e.g., air or water vapor, the deposited metal electrode, etc.) and thereby change its mechanical and electrical properties.

FIG. 5 illustrates one embodiment of a cross-sectional view of the lead iodide film after isostatic pressing as described in FIG. 3. The integrated circuit 400 is shown having a top electrode 405, a densified lead iodide layer 415, and an ITO electrode 425. The crystalline lead iodide particles are tightly connected to each other because the gaps are pressed out. Densification of the deposited lead iodide film lessens the gaps within the lead iodide film, thereby producing greater mechanical strength, enhancing the adhesion of the deposited film to the underlying substrate, increasing the circuit connectivity, and smoothing the surface topology of the deposited lead iodide film. In one embodiment, the density of the semiconducting film layer has a bulk density of roughly 90% of the 6.2 g/cm3 characteristic of crystalline lead iodide. This is compared to the film layer shown in FIG. 4 which had a density of only 50% to 70% of that value.

Furthermore, in the application of a device having the densified semiconducting layer, such as in digital imaging systems, the dense, thick semiconducting layer allows for increased absorption and conversion of radiation in X-ray detectors. Therefore, the densified semiconducting layer provides for larger signal amplitude due to direct X-ray detection, increased detection efficiency (e.g., due to the increased stopping efficiency of the lead iodide film), and increased spatial resolution due to lesser lateral diffusion of charges.

It will be appreciated that more or fewer processes may be incorporated into the method(s) illustrated in FIGS. 2 and 3 without departing from the scope of the invention and that no particular order is implied by the arrangement of blocks shown and described herein. It further will be appreciated that the method described in conjunction with FIGS. 2 and 3 may be embodied in machine-executable instructions, e.g. software. The instructions can be used to cause a mechanical device, such as, a robotic arm assembly having a general-purpose or special-purpose processor that is programmed with the instructions, to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result.

Thus, an isostatic pressing technique to densify a deposited semiconducting material on an integrated circuit, is described. The isostatic nature allows for intricate shapes to be handled that could not otherwise be handled with mechanical presses. Also, it should be appreciated that isostatic pressing provides the option of densifying semiconducting films after deposition onto fragile substrates, such as, glass, ceramics, etc., and semiconductor wafers such as silicon. In contrast, mechanical pressing techniques that use paltens may cause breakage of fragile substrates, such as glass, on which the semiconducting films are deposited. It should be appreciated that use of isostatic pressure avoids this because the glass substrate is not pressed against an immovable plate.

Nevertheless, mechanical presses may also be used to densify the semiconducting particles as well as using heat to provide increased adhesion between the semiconducting particles, each well known to those of ordinary skill in the art. For example, mechanical pressing may be accomplished with a rubber mold that holds the powder and describes the desired form. For processing lead iodide films, the final shape is largely defined during the vapor deposition stage (through masking). The pressing action may occur through either gases or liquids. For example, gases may be used in hot isostatic pressing.

It should be understood that additional methods to apply heat to a film, such as other well known annealing techniques that result in densification of the film, may also be used, but are not described herein in detail so as not obscure the invention. In addition, although the description describes using isostatic pressing upon vapor deposited films of lead iodide, alternatively, screen-printed lead iodide film techniques well known to those of ordinary skill in the art might also be used.

It should also be understood that the term “coupled” as used herein means coupled directly to or indirectly through one or more intervening components. For example, two or more layers of different semiconducting material may be used to alter the electronic properties of the resulting device. Multiple layers could also be applied to increase the overall thickness if a single deposition of such thickness is not feasible. Regarding intervening layers, these could be applied to the substrate prior to the pressing process and the film deposition process in order to enhance adhesion, serve as a protective barrier or alter electronic properties.

While the invention has been described in terms of several embodiments, those skilled in the art will recognize that the invention is not limited to the embodiments described. The method and apparatus of the invention can be practiced with modification and alteration within the scope of the appended claims. The description is thus to be regarded as illustrative instead of limiting on the invention.

What is claimed is:

1. A method for densifying a film on a substrate comprising:
providing a substrate having a film; and
applying pressure to densify the film on the substrate.

2. The method of claim 1, wherein the applying pressure further comprises:
enclosing the substrate having the film within an enclosure;
submerging the enclosure enclosing the substrate having the film within a liquid;
applying isostatic pressure to the enclosure enclosing the substrate having the film; and
removing the enclosure enclosing the substrate having the film from the liquid.

3. The method of claim 2, further comprising:
covering a surface of the film with a release layer.

4. The method of claim 3, further comprising:
removing the release layer from the surface of the film.

5. The method of claim 2, wherein enclosing the substrate having the film within the enclosure includes vacuum-sealing the enclosure.

6. The method of claim 5, wherein vacuum-sealing the enclosure includes vacuum-sealing the enclosure with a vacuum pump.

7. The method of claim 2, wherein enclosing the enclosure includes heat-sealing the enclosure.

8. The method of claim 2, wherein the applying isostatic pressure includes applying cool isostatic pressure.

9. The method of claim 2, wherein the enclosure is a polynatural bag.

10. The method of claim 2, wherein the film is a semiconducting film.

11. The method of claim 2, wherein the film comprises lead iodide.

12. The method of claim 2, wherein the liquid comprises water.

13. The method of claim 2, wherein the liquid comprises hydraulic oil.

14. The method of claim 2, wherein the release layer is a Teflon sheet.

15. The method of claim 1, wherein the applying pressure includes applying mechanical pressure to densify the film.

16. A method for densifying a film on a substrate comprising:
providing a substrate having a film; and
applying a means for densifying the film on the substrate.

17. The method of claim 16, wherein the means for densifying the film includes a means for applying isostatic pressure to the film.

18. The method of claim 17, wherein the means for applying isostatic pressure to the film includes applying isostatic pressure while the film is submerged in a liquid.

19. The method of claim 18, further comprising applying a means for protecting the film from contaminates while the film is submerged in the liquid.

20. The method of claim 16, wherein the film is a semiconducting film.

21. The method of claim 16, wherein the film comprises lead iodide.

22. The method of claim 16, further comprising submerging the film in water.

23. The method of claim 18, further comprising submerging the film in hydraulic oil.

24. An x-ray detector comprising:
a substrate; and
a densified film coupled to the substrate.

25. The x-ray detector of claim 24, wherein the film is a semiconducting film.

26. The x-ray detector of claim 24, wherein the film is a lead iodide film.

27. The x-ray detector of claim 26, wherein the lead iodide film is an isostatic pressurized lead iodide film.

28. The x-ray detector of claim 24, wherein the film is a bismuth iodide film.

29. The x-ray detector of claim 24, wherein the film is a bismuth thiodide film.

30. The x-ray detector of claim 24, wherein the film is a mercuric iodide film.

31. The x-ray detector of claim 30, wherein the mercuric iodide film is an isostatic pressurized mercuric iodide film.

32. The x-ray detector of claim 24, wherein the substrate is a fragile substrate.

33. The x-ray detector of claim 24, wherein the substrate is a glass substrate.

34. The x-ray detector of claim 24, further comprising:
a first electrode coupled to the densified film;
a second electrode coupled to the lead iodide film layer; and
electronic circuitry coupled to the second electrode and the substrate.

35. An x-ray detector comprising:
a substrate;
electronic circuitry coupled to the substrate; and
means for increasing conversion of radiation into charge pairs that can be measured by the electronic circuitry, said means being coupled to the electronic circuitry, wherein the means for increasing the conversion includes densifying a semiconducting layer.

36. The x-ray detector of claim 35, wherein the means for increasing the conversion of radiation includes the semiconducting layer being densified by isostatic pressure.

37. The x-ray detector of claim 35, wherein the means for increasing the conversion of radiation includes the semiconducting layer being densified by mechanical pressure.

38. A method comprising:
enclosing a substrate having a film within a bag;
submerging the bag enclosing the substrate having the film within a watch bath;
applying isostatic pressure to the bag enclosing the substrate having the film; and
removing the bag enclosing the substrate having the film from the watch bath.

39. The method of claim 38, further comprising:
covering a surface of the film with a release layer.

40. The method of claim 39, further comprising:
removing the release layer from the surface of the film.

41. The method of claim 38, wherein enclosing the substrate having the film within the bag includes vacuum-sealing the bag.

42. The method of claim 41, wherein vacuum-sealing the bag includes vacuum-sealing the bag with a vacuum pump.

43. The method of claim 38, wherein enclosing the bag includes heat-sealing the bag.

44. The method of claim 38, wherein the applying isostatic pressure includes applying cool isostatic pressure.

45. The method of claim 38, wherein the bag is a polynatural bag.

46. The method of claim 38, wherein the film is a semiconducting film.

47. The method of claim 38, wherein the film comprises lead iodide.

48. The method of claim 38, wherein submerging the bag includes submerging the bag within a liquid.

49. The method of claim 48, wherein submerging the bag includes submerging the bag in water.

50. The method of claim 48, wherein submerging the bag includes submerging the bag in hydraulic oil.

51. The method of claim 39, wherein the release layer is a Teflon sheet.
